(19) United States
(12) Patent Application Publication
(10) Pub. No.: US 2012/0300092 A1
(43) Pub. Date: Nov. 29, 2012

(54) AUTOMATICALLY OPTIMIZING CAPTURE OF IMAGES OF ONE OR MORE SUBJECTS

(75) Inventors: CHANWOO KIM, Bellevue, WA (US); CHARBEL KHAWAND, Sammamish, WA (US); JUNGHWAN MOON, Bellevue, WA (US)

(73) Assignee: MICROSOFT CORPORATION, REDMOND, WA (US)

(21) Appl. No.: 13/333,121

(22) Filed: Dec. 21, 2011

Related U.S. Application Data
(60) Provisional application No. 61/488,933, filed on May 23, 2011.

(51) Int. Cl. H04N 5/228

(52) U.S. Cl. 348/222.1

(57) ABSTRACT

Capturing and storing an optimized images of a subject are described herein. Images of the subject may be captured while in a live mode or burst mode. The photographer or user administering the photographs may wish to have an image with one or more optimized features. Within the plurality of images, the optimized feature for each subject is found and used to compose an optimized image, and the optimized image may be stored.

### CROSS-REFERENCE TO RELATED APPLICATIONS

This application claims priority to Provisional Application Ser. No. 61/488,933, filed on May 23, 2011 and entitled “AUTOMATICALLY OPTIMIZING CAPTURE OF IMAGES OF ONE OR MORE SUBJECTS.”

### BACKGROUND

The current state of taking photographs involves taking pictures of one or more persons and hoping that the picture is suitable. Alternately, once the pictures are taken, post-processing may be done on the pictures to alter them so that everyone in the picture has their eyes open, is smiling, etc. Yet, because the moment of capturing the image has passed, if the post-processed image is still not suitable, the photographer has no recourse.

### SUMMARY

Embodiments of the present invention generally relate to capturing an image with optimized subject features. When trying to capture an image of a person or more than one person, it may be difficult to coordinate all of the persons with their eyes open, smiling, or with other expressions that are desired. With more people in an image, it becomes increasingly difficult to capture all of the subjects with optimal facial expressions. Using the embodiments described herein, a plurality of images of subjects may be captured. The captured images may form a story board in which faces of subjects may be detected. At least one feature of the subjects in found within the plurality of images, and an image in which the feature may be optimized may be selected. Then, an optimized image may be created and stored with the feature of the subjects.

Embodiments are defined by the claims below, not this summary. A high-level overview of various aspects are provided here for that reason, to provide an overview of the disclosure, and to introduce a selection of concepts that are further described below. This summary is not intended to identify key features or essential features of the claimed subject matter. Nor is it intended to be used as an aid in isolation to determine the scope of the claimed subject matter.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts a block diagram of an exemplary computing environment suitable for implementing embodiments discussed herein.

FIG. 2 depicts a flow chart of an exemplary method for automatically storing a photo of a person with open eyes, according to one embodiment.

FIG. 3 depicts a block diagram of a system for automatically storing a photo of a person with open eyes, according to one embodiment.

FIG. 4 depicts a flow chart of an exemplary method for automatically capturing an optimized image of one or more subjects, according to one embodiment.

FIG. 5 depicts a flow chart of an exemplary method for automatically storing an optimized image with optimized features in the subjects, according to one embodiment.

FIG. 6 depicts a flow chart of an exemplary method for automatically storing an optimizing image of a subject having at least one optimized feature, according to one embodiment.

FIGS. 7A-B depicts examples of a storyboard and optimized image, according to one embodiment.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

The present invention relates generally to automatically capturing optimized images of subjects. With the adoption of camera phones, digital cameras, and other camera-containing devices, users are taking more pictures. Particularly, with cloud storage and social networking, instantly uploading captured photographs for display to others is increasingly popular. Yet, captured images may not be especially flattering to the subjects of the photographs. When uploading without access to post-processing programs, what was captured is what will be shown to the world. Herein is presented a method for optimizing images as they are captured, so that stored images represent the best images of the features of the subjects.

In one embodiment, one or more computer-storage media may have computer-executable instructions embodied thereon, that, when executed, automatically capturing an image with optimized subject features. Images of one or more of the subjects are captured, and a face of the one or more subjects is detected. A feature is found in the one or more subjects. An image with the feature is selected, optimized, and stored as an optimized image with the feature of the one or more subjects.

Another embodiment automatically captures an image with optimized subject features. A plurality of images of one or more subjects are captured with a camera. At least one optimized feature of the one or more subjects is found in the plurality of images. An optimized image with the at least one optimized feature of the one or more subjects is eventually stored.

In another embodiment, one or more computer-storage media may have computer-executable instructions embodied thereon that, when executed, automatically captures an image with optimized subject features. A first face of a first subject may be detected, and a plurality of images of the first subject may be captured. A first additional feature of the first subject in the plurality of images is detected and at least one of the plurality of images is identified in which the first additional feature is optimized. At least one optimized image with the optimized first additional feature of the first subject is eventually stored.

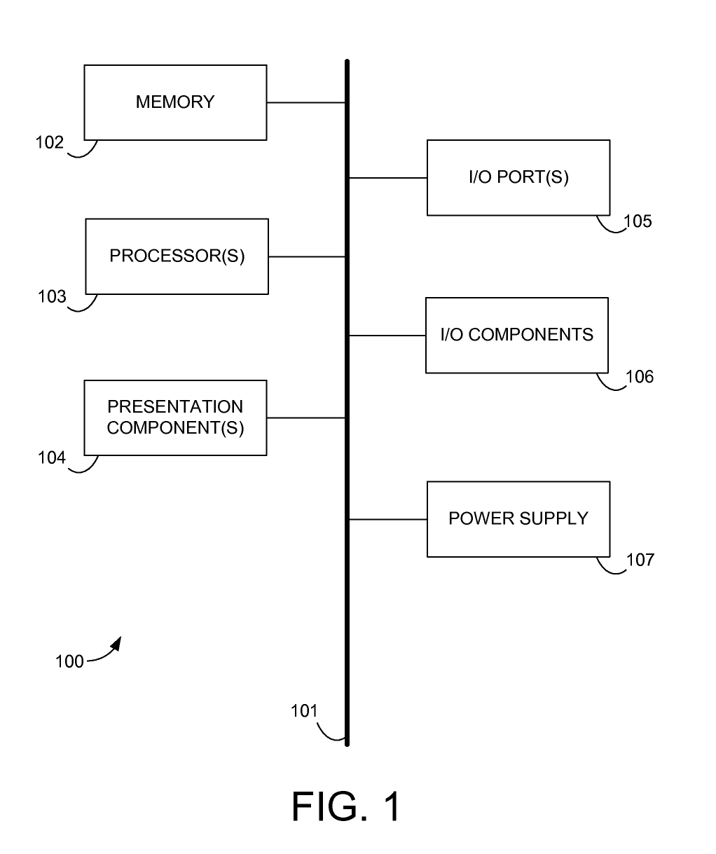

Having briefly described in an overview of the present invention, an exemplary operating environment in which various aspects of the present invention may be implemented is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks may be performed by remote-processing devices that may be linked through a communications network.

With continued reference to FIG. 1, computing device 100 includes a bus 101 that directly or indirectly couples the following devices: memory 102, one or more processors 103, one or more presentation components 104, input/output (I/O) ports 105, I/O components 106, and an illustrative power supply 107. Bus 101 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer-storage media and communication media. Computer-storage media includes both volatile and nonvolatile, removable and non-removable media implemented in any method or technology for storage of information such as computer-readable instructions, data structures, program modules or other data. Computer-storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 100.

The memory 102 includes computer-storage media in the form of volatile and/or nonvolatile memory. The memory 102 may be removable, non-removable, or a combination thereof. Exemplary hardware devices include solid-state memory, hard drives, optical-disc drives, etc. The computing device 100 includes one or more processors that read data from various entities such as the memory 102 or the I/O components 106. The presentation component(s) 104 present data indications to a user or other device. Exemplary presentation components include a display device, speaker, printing component, vibrating component, and the like.

The I/O ports 105 allow the computing device 100 to be logically coupled to other devices including the I/O components 106, some of which may be built in. Illustrative I/O components 106 include a microphone, joystick, game pad, satellite dish, scanner, printer, wireless device, and the like.

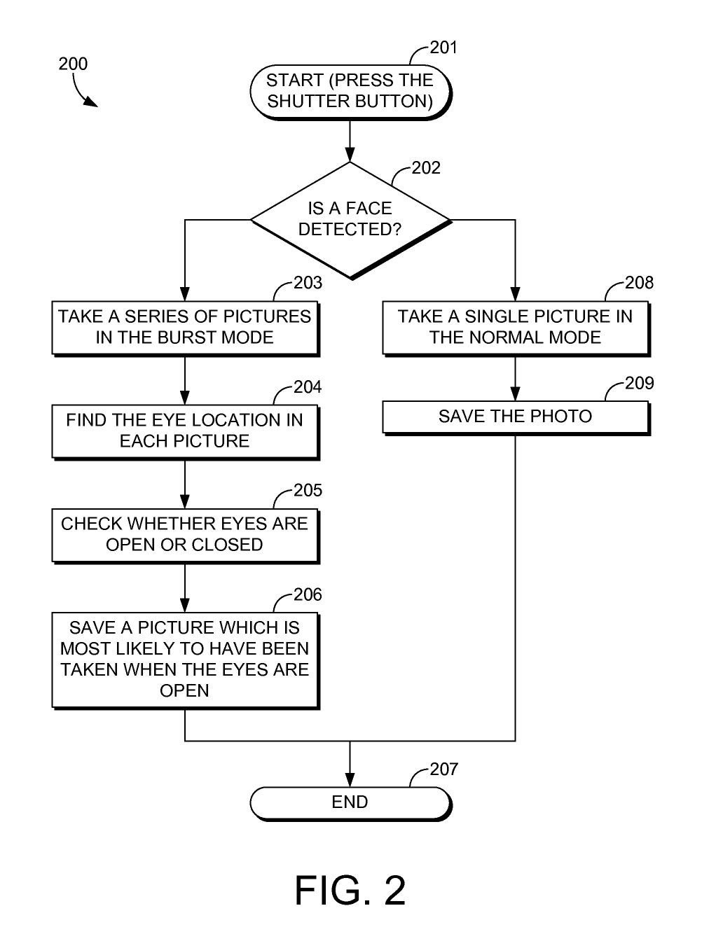

FIG. 2 depicts automatically capturing an image with optimized subject features is provided, according to one embodiment. A user employing a digital camera, camera phone, or the like may press or otherwise actuate the shutter button at step 201. If a face of a subject is detected, the camera may take a series of pictures or images in “burst mode,” which captures a plurality of pictures in a short period of time. In each picture or image in the series, the locations of eyes of the subjects may be determined within the face regions identified in step 203. In one embodiment, there may be many possible eye tracking algorithms. The eyes of the subjects may be checked to see if they are open or closed, as shown at 205. If there is a single image where all of the subjects' eyes are opened, that image may be selected. But if each subject displays optimal eye opening in different images, an optimized image may be composed using the optimized features in the selected images. Thus a photo which is most likely to include opened eyes for the subjects is saved, as shown at 206. The remaining images taken in burst mode may be discarded. Alternately, if a face of a subject is not detected, the camera takes a single image or picture in a normal or other conventional mode (shown at 208) and saves the single image (shown at 209).

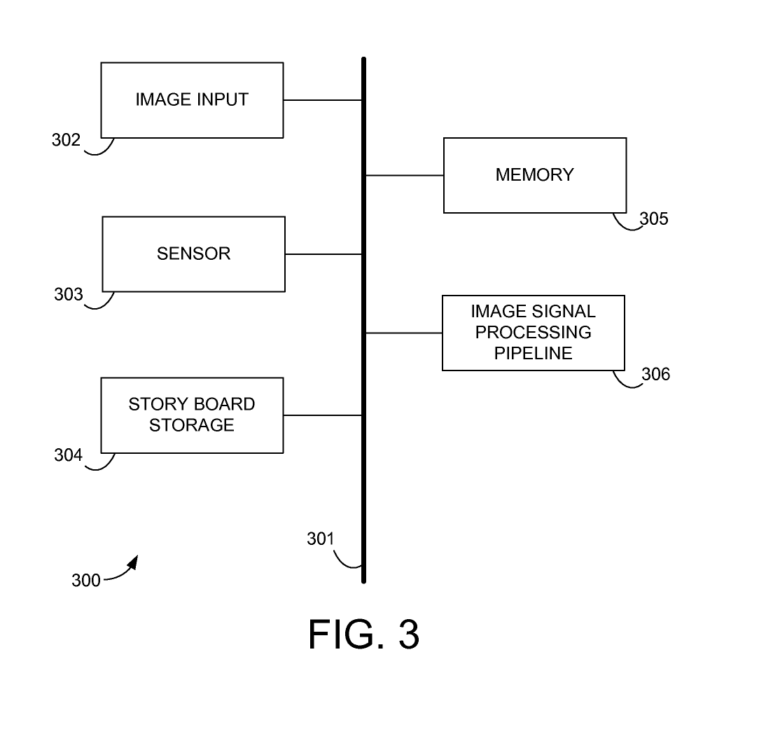

Referring to FIG. 3, an exemplary system 300 for automatically capturing an image with optimized subject features is illustrated. The image input 302 and sensor 303 may include any image sensor, including a charge couple device (CCD) sensor or complementary metal-oxide-semiconductor (CMOS) sensor. The storyboard 304 may be a temporary buffer to store the plurality of images captured in burst mode and tied 301 to the image signal processing pipeline 306. The image signal processing pipeline may run one or more facial detection algorithms, eye tracking algorithms, and/or binary pattern classifiers to check for optimized features, and/or various training algorithms and databases. The image signal processing pipeline 306 may include a series of rules used to compose the optimized image. Following optimization by the image signal processing pipeline 306, the optimized image may be stored in a memory 305. Memory 305 may include Random Access Memory (RAM), Read Only Memory (ROM), Electronically Erasable Programmable Read Only Memory (EEPROM), flash memory, or other memory technology, CD-ROM, digital versatile disks (DVD) or other holographic memory, magnetic cassettes, magnetic tape, magnetic disk storage or other magnetic storage devices, or any other medium that can be used to encode desired information.

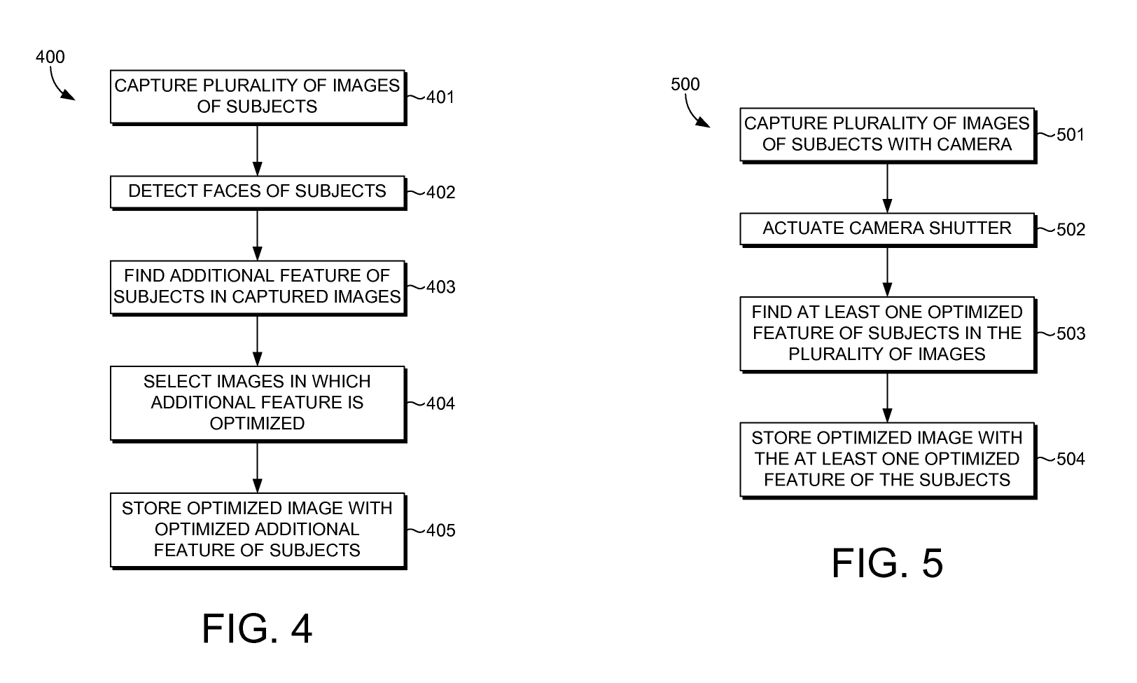

FIG. 4 depicts a flow 400 for automatically capturing optimized subject features, according to one embodiment. Using a camera-containing device, a plurality of images of subjects may be captured, as shown at 401. For example, a father may be taking a picture of three children. The camera-containing device may capture a plurality of images of the three children posed in front of a Christmas tree. The camera-containing device may be running a facial detection algorithm that automatically takes the plurality of images in burst mode when one or more faces is detected. Alternately, the camera user may manually select the facial recognition or burst mode. The faces of the subjects may be detected at step 402 and at least one additional feature of the subjects may be selected, as shown at 403. For example, the father may want a picture with all of the children smiling. There may be numerous examples of feature tracking algorithms and the image processing pipeline may include training algorithms to aid in detection of new optimized features. Training databases, such as one with pictures of people smiling and one with pictures of people not smiling, may be employed. Binary pattern classifier techniques, such as a Support Vector Machines (SVMs), Principal Component Analysis (PCA), etc., may also be used for the decision and selection.

Images within the plurality of captured images may be selected, as shown at 404, in which the feature is optimized. For example, an image processing pipeline may find a smile for each child within the plurality of images. Finally, an optimized image in which the feature may be optimized for the subjects may be stored, as shown at 405. For example, a picture of all three children in front of a Christmas tree with smiles on their faces may be stored as the final image.

In addition, the camera-containing device may include a database of previously identified optimized features for a plurality of subjects. For example, the father taking a picture of the children may have stored previous images of the children smiling. If the images captured in the plurality of images in front of the Christmas tree fail the feature optimization, then previously captured images may be used to compose the optimized image. For example, a picture of one of the children smiling the beach may be used to optimize the image of the child in front of the Christmas tree so that he is smiling in the optimized image.

Furthermore, capturing the plurality of images of the subjects may occur before and after the shutter or other camera actuation. For example, many camera-containing devices include a “live mode,” which is not used to compose the final image but merely as a viewfinder. The “live mode” images may be taken as a part of the plurality of images captured even before the camera shutter is actuated.

FIG. 5 depicts a flow 500 for automatically capturing an image with optimized subject features, such as a method in which “live mode” images may be used to form the optimized image, according to one embodiment. A plurality of images of subjects may be captured with a camera, as shown at 501. This plurality of images may form a storyboard and may be captured in a camera “live mode” or viewfinder mode. The capture of the plurality of images may also be spaced apart in time. For example, the plurality of images of the subjects may have been captured in the past and form an image database for the subjects. A camera shutter of a camera-containing device may be actuated, as shown at 502. At least one optimized feature of the subjects may be found within the plurality of images, as shown at 503. This step may also comprise detecting the faces of the subjects and the locating the feature to be optimized as previously described.

To store the optimized image with the feature of the subjects optimized, such as in step 504, the image processing pipeline may select an image in the plurality of images that most likely contains the optimized features. The image processing pipeline may use feature mapping information to artificially adjust the features using selected optimized features from the plurality of images. In one embodiment, images in the plurality of images that are not used may be discarded. The unused images may contribute to the training databases. The images determine to include optimized feature of one or more subjects may contribute to an optimizer database to be used in composing future optimized images. For example, images of family members with eyes open may be used to compose future images of the family members with eyes open.

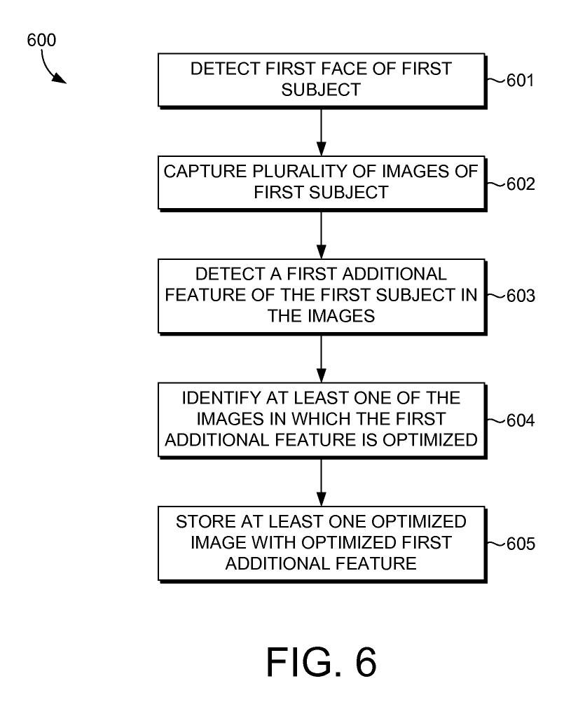

FIG. 6 illustrates a flow 600 for automatically capturing an image with optimized subject features, according to one embodiment. Flow 600 may be stored on various computer-storage media for use with a camera-containing device. A camera containing device may include facial detection software to detect a face of a subject, as shown at 601. In one example, the camera-containing device may run a live mode or viewfinder mode in which a face of a subject is detected, as shown at 601. If a face of a subject is detected, a plurality of images of the subject is captured, as shown at 602. The plurality of images may be captured in a burst mode when the camera shutter is actuated. The plurality of images may be captured in the camera live mode or viewfinder mode. In each image of the plurality of images, a first additional feature of the first subject may be detected, as shown at 603. This additional feature may be detected using various algorithms, such as an eye tracking algorithm for detecting eye location in the first subject. The image in which the at least one additional feature is optimized is identified in step 604. As described above, the optimization of the feature may be determined using training databases to establish a binary classification, for example: eyes open or eyes closed. Any binary pattern classifier techniques may be used for the decision. Among the plurality of images taken in step 602, at least one optimized image with the optimized feature of the first subject is stored, as shown at 605.

As described above, in capturing images with a second subject, the optimized feature of the second subject may also be detected and identified within the plurality of images. The optimized feature of the second subject may be used to compose the stored optimized image. The image processing pipeline may apply rules to compose the image; for example, if multiple features are to be optimized, feature #1, eyes open, may be weighted more heavily than feature #2, smiling, in composing the optimized image, or vice versa.

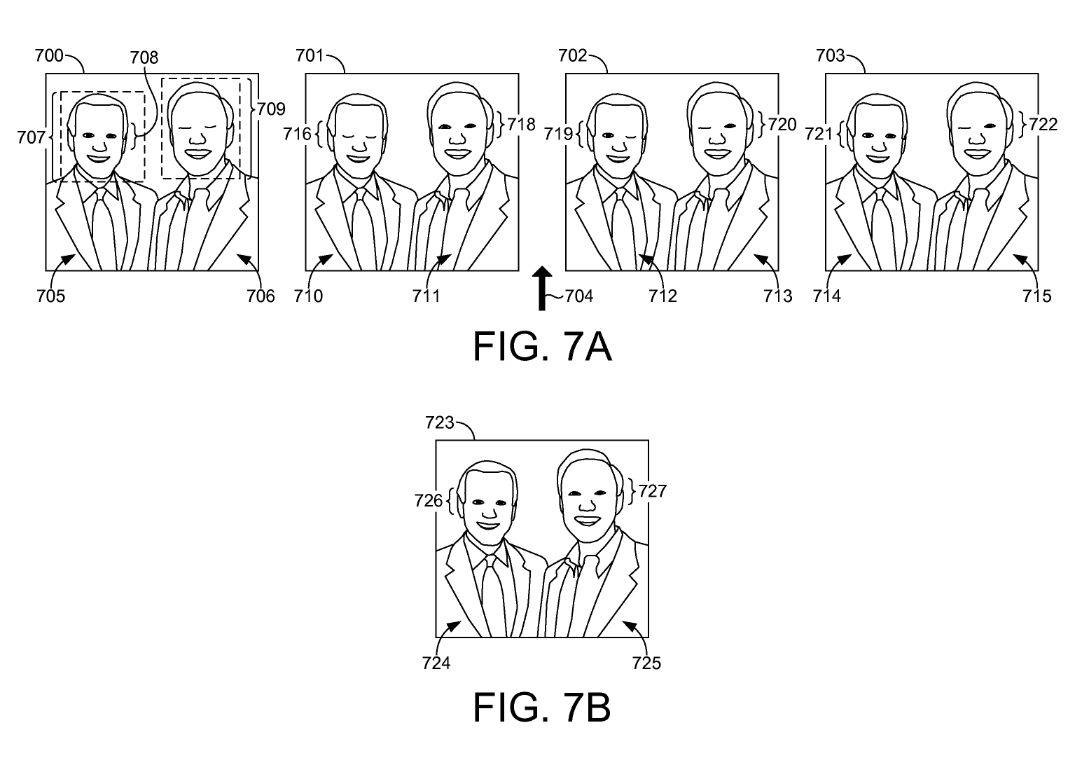

In FIGS. 7A and 7B, an example of automatically capturing an image with optimized subject features is illustrated, according to one embodiment. In FIG. 7A, a plurality of images 700-703 may form a story board or a portion of a story board. The images include a first subject 705 and a second subject 706. The camera-containing device may detect a first face 707 of the first subject 705 and/or the second face 709 of the second subject 706. The facial detection may automatically trigger the burst mode or storyboard capture. The camera-containing device may capture the plurality of images 700-703 of the first subject 705 and the second subject 706; however the shutter actuation may occur at any point in the series of images, for example at 704. The camera-containing device may use any facial detection algorithm to detect the faces 707 and 709 of the first subject 705 and the second subject 706. The image processing pipeline may also use eye tracking algorithms to detect the locations of the eyes of the first subject 716, 719, 721 and the location of the eyes 718, 720, 722 of the second subject in each image of the plurality of images 700-703. A binary pattern classifier may determine or identify an image 703 in which the first subject's eyes are open 721 and an image 701 in which the second subject's eyes are open 718. An optimized image, as shown in FIG. 7B, may be composed using various rules and the selected optimal features. As shown in FIG. 7A, none of the images includes the first subject and the second subject with eyes open. In FIG. 7B, the stored optimized image 723 includes the first subject 724 with eyes open 726 and the second subject 725 with eyes open 727 as well.

Numerous features may be identified and optimized using the above-described methods and systems. For example, one feature to be identified and optimized may be smiles in the subjects. Another feature may be all of the subjects performing an action: such as all subjects jumping or holding a specific pose. The subjects may be non-human subjects. For example, animal photographers may wish to optimize features in animal subjects. In this case, the automatic optimized image capture is even more useful in subjects that may be even more difficult to arrange or predict. Different features of non-human subjects may be selected using training databases and algorithms.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-storage media having computer-executable instructions embodied thereon that, when executed, perform a method for automatically capturing an image with optimized subject features, the method comprising:
capturing a plurality of images of one or more subjects;
detecting at least one face of the one or more subjects;
finding at least one feature of the one or more subjects in the plurality of images of the one or more subjects;
selecting an image in which the at least one feature of the one or more subjects is optimized; and
storing at least one optimized image comprising the at least one feature of the one or more subjects.

2. The media of claim 1, wherein the at least one feature is eyes of the one or more subjects and the optimized feature includes opened eyes of the one or more subjects.

3. The media of claim 1, wherein the at least one feature is a mouth of the one or more subjects and the optimized feature includes a smiling mouth of the one or more subjects.

4. The media of claim 1, wherein the at least one optimized image includes an artificial adjustment to include the optimized feature of each of the subjects.

5. The media of claim 1, wherein capturing the plurality of images of the subjects further comprises capturing a portion of the images in burst mode following a camera shutter actuation.

6. The media of claim 1, wherein capturing the plurality of images of the subjects further comprises capturing a portion of the images in live mode.

7. A method of automatically capturing an image with optimized subject features, the method comprising:
capturing a plurality of images of one or more subjects with a camera;
actuating a shutter release of the camera;
finding at least one optimized feature of the one or more subjects in the plurality of images of the one or more subjects; and
storing at least one optimized image comprising the at least one optimized feature of the one or more subjects.

8. The method of claim 7, wherein finding the at least one optimized feature comprises locating a face of the one or more subjects and locating a feature of the one or more subjects and determining an image in the plurality of images with the at least one optimized feature.

9. The method of claim 8, wherein determining the at least one optimized feature is done with a binary pattern classifier

10. The method of claim 7, wherein storing at least one optimized image further comprises storing one of the plurality of images with the most optimized features of the subjects.

11. The method of claim 7, further comprising composing an optimized image using the at least one optimized feature of the one or more subjects determined.

12. The method of claim 7, wherein capturing the plurality of images subjects further comprises capturing a portion of the images in live mode prior to actuating the camera shutter.

13. One or more computer-storage media having computer-executable instructions embodied thereon that, when executed, perform a method for automatically capturing an image with optimized subject features, the method comprising:
detecting a first face of a first subject;
capturing a plurality of images of the first subject;
detecting a first additional feature of the first subject in the plurality of images;
identifying at least one of the plurality of images in which the first additional feature is optimized; and
storing at least one optimized image comprising the optimized first additional feature of the first subject.

14. The media of claim 13, the method further comprising:
detecting one or more additional faces of one or more additional subjects in the plurality of images;
detecting one or more additional features of the one or more additional subjects in the plurality of images; and
identifying at least one of the plurality of images in which the one or more additional features is optimized, wherein the at least one optimized image further comprises the optimized one or more additional features of the one or more additional subjects.

15. The media of claim 13, wherein the first additional feature is eyes of the first subject and the optimized feature includes opened eyes of the first subject.

16. The media of claim 13, wherein the first additional feature is a mouth of the first subject and the optimized feature includes a smiling mouth of the first subject.

17. The media of claim 13, the method further comprising composing an optimized image using the optimized first additional feature of the first subject.

18. The media of claim 13, the method further comprising:
detecting a second feature of the first subject in the plurality of images; and
identifying at least one of the plurality of images in which the second feature is optimized, wherein the at least one optimized image further comprises the optimized second feature of the first subject.

19. The media of claim 13, the method further comprising:
capturing the plurality of images further comprises capturing a portion of the images in burst mode following a camera shutter actuation.

20. The media of claim 13, the method further comprising:
capturing the plurality of images further comprises capturing a portion of the images in live mode.
